(19) United States
(12) Patent Application Publication
(10) Pub. No.: US 2005/0236972 A1
(43) Pub. Date: Oct. 27, 2005

(54) Light emitting display (LED) and method of manufacture

(76) Inventors: Moon-Hee Park, Suwon-si (KR); Chang-Su Seo, Suwon-si (KR)

Correspondence Address: ROBERT E. BUSHNELL, 1522 K STREET NW, SUITE 300, WASHINGTON, DC, 20005-1202, US

(21) Appl. No.: 11/100,639

(22) Filed: Apr. 7, 2005

(30) Foreign Application Priority Data
Apr. 7, 2004 (KR) 10-2004-0023799

(51) Int. Cl. H05B 33/08; H05B 33/10

(52) U.S. Cl. 313/503; 313/506; 313/509; 445/24

(57) ABSTRACT

A Light Emitting Display (LED) includes: a display region including first and second electrodes having at least one layer formed on a substrate layer and a light emitter arranged between a first and second electrodes; and a terminal unit including at least one terminal arranged on an outer region of the display region; wherein at least a portion of the at least one terminal of the terminal unit includes an upper terminal conductive layer and a lower terminal conductive layer, each including at least one layer, and at least one layer of the upper terminal conductive layer is of a material identical to at least a portion of the second electrode layer.

### CLAIM OF PRIORITY

This application makes reference to, incorporates the same herein, and claims all benefits accruing under 35 U.S.C. §119 from an application entitled ELECTRO-LUMINESCENCE DISPLAY DEVICE AND METHOD FOR PRODUCING THE SAME filed with the Korean Intellectual Property Office on Apr. 7, 2004, and there duly assigned Serial No. 10-2004-0023799.

### BACKGROUND OF THE INVENTION

1. Field of the Invention

The present invention relates to a Light Emitting Display (LED), and more particularly, to an light emitting display that can increase the operability and lifetime by increasing a coupling force with electrical elements such as a Flexible Printed Circuit (FPC) or Chip on Glass (COG) by preventing corrosion of terminals of exposed terminal units to the outside.

2. Description of the Related Art

Flat display devices, such as Liquid Crystal Displays (LCDs), Organic Light Emitting Displays (OLEDs), or Inorganic Light Emitting Displays (ILEDs) can be classified as Passive Matrix (PM) displays or Active Matrix (AM) displays according to their method of operation. In a PM display, the anodes and the cathodes are simply arranged in columns and rows, respectively, and scanning signals are supplied to the cathodes from a row driving circuit. Only one row is selected from a plurality of rows. Also, data signals are supplied to each pixel from the column driving circuit. On the other hand, in an AM display, control signals are inputted to each pixel using a Thin Film Transistor (TFT). AM displays are widely used for implementing animation since they are suitable for processing a large number of signals.

The OLED has an organic light emitting layer composed of an organic material arranged between a cathode and an anode. When anode and cathode voltages are respectively supplied to the anode and the cathode, holes injected from the anode are transferred to an organic fluorescent layer via a hole transfer layer and electrons are injected into the organic fluorescent layer via an electron transfer layer from the cathode. The OLED can display images using light emitted from fluorescent molecules of an organic light emitting layer according to the transformation of exitons from an excited state to a ground state, wherein the exitons are generated by recombining electrons and holes in the organic fluorescent layer. Full color can be implemented by including pixels emitting red, green and blue light.

In a flat display device, especially in an OELD, a display region composed of pixels is formed on a substrate, wiring is formed on peripheral regions of the display region, and circuit units, such as electrode power supply lines and a vertical driving circuit, and a sealing unit that at least seals the display region using a sealing member with a sealing substrate (not shown) are arranged thereon. Also, a pad unit is arranged on at least a peripheral area of the display region.

The pad unit includes a buffer layer, a gate insulating layer, and an interlayer sequentially formed on the substrate. The buffer layer, the gate insulating layer, and the interlayer are equivalent layers formed in the display region. A layer, which is the equivalent layer of source and drain electrodes in the display region formed of MoW, is formed above the interlayer. The layer acts as terminals of the pad unit.

However, oxide films can be formed on a surface of the terminals since these terminals are exposed to unfavorable conditions, such as humidity and high temperatures. The oxide films interrupt smooth electrical communications between terminals of an outside electrical device, such as an FPC or COG.

In a top emission display, the anode layer is a double layer composed of a reflection electrode and a transparent electrode. An electrode layer equivalent to one of the reflection electrode and the transparent electrode forms the uppermost part of a conductive layer of the pad unit. Aa protective layer is disposed on a surface of the equivalent layer as the source/drain electrode, and the anode layers are disposed on the protective layer. The anode layer is electrically connected to the equivalent layer as the source/drain electrode through via holes formed in the protective layer.

However, the anode layers are easily damaged by humidity since they are exposed to atmospheric air. That is, the reflection electrode of the anode is formed of an aluminum (Al) layer or an Al alloy layer such as AlNd to increase reflectability, and the transparent electrode of the anode is formed of a metal oxide layer, such as ITO. When an Al layer or a layer composed of AlNd is exposed to atmospheric air, the pad unit corrodes due to a galvanic phenomenon occurring at an interface between the metal layer and the metal oxide layer, and, in a worst case, the pad unit may peel off.

Korea Patent Publication No. 2003-58325 discusses a contact structure in which an aluminum nitride (AlNd) film is formed between a transparent conductive metal layer and an aluminum layer. However, an additional deposition process is needed for forming the AlN film, and there is a risk of damaging the OELD during deposition. Also, the formation of the AlN film does not effectively prevent the occurrence of the galvanic phenomenon even though it can prevent the formation of an oxide film on the Al layer.

Korean patent publication No. 2003-57122 discusses a method of forming a sacrificial layer such as an Mo layer to prevent a galvanic phenomenon, but this method also requires an additional process.

Japanese Laid-Open Patent Publication No. 2002-33188 discusses an OELD in which a non-corrosion metal material is disposed between an external electrode and a cathode layer. This also requires an additional process, thereby increasing manufacturing costs.

### SUMMARY OF THE INVENTION

The present invention provides an light emitting display device having a structure that can increase the lifetime of the device by preventing corrosion of terminals and illumination differences of the display, caused by resistance difference between terminals, and being manufactured without an additional process.

According to one aspect of the present invention, a Light Emitting Display (LED) is provided comprising: a display region including first and second electrodes having at least one layer formed on a substrate layer and a light emitter arranged between a first and second electrodes; and a terminal unit including at least one terminal arranged on an outer region of the display region; wherein at least a portion of the at least one terminal of the terminal unit includes an upper terminal conductive layer and a lower terminal conductive layer, each including at least one layer, and at least one layer of the upper terminal conductive layer is of a material identical to at least a portion of the second electrode layer.

According to another aspect of the present invention, a method of manufacturing a Light Emitting Display (LED) is provided, the method comprising: arranging a display region to include first and second electrodes having at least one layer arranged on a substrate layer and a light emitter arranged between the first and second electrodes; and arranging a terminal unit including at least one terminal arranged on an outer region of the display region, arranging the terminal unit including: forming a lower terminal conductive layer with at least one layer equivalent to a gate electrode layer and one layer equivalent to source/drain electrodes of the display region; and forming the upper terminal conductive layer equivalent to at least a portion of the second electrode layer of the display region.

According to the present invention, the electrical resistance of the terminals of a terminal unit can be reduced by preventing oxidation of the terminals when exposed to humidity and high temperatures. Furthermore, the lifetime of an LED can be increased by reducing the probability of damage to a terminal unit due to a galvanic phenomenon.

Also, according to the present invention, workability of an LED can be increased since electrical connections and couplings with external devices, such as FPC and COG, can be improved by reducing the probability of damage to the terminals and forming the terminals of the terminal unit with more than one layer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1A is a plan view of an organic light emitting display device;

FIGS. 1B and 1C are cross-sectional views of a pad unit taken along line A-A of FIG. 1A;

FIGS. 1D and 1E are photo images of a pad unit, before and after corrosion;

FIG. 2A is a plan view of an OELD according to an embodiment of the present invention;

FIG. 2B is a magnified drawing of B of FIG. 2A;

FIG. 2C is cross-sectional view taken along line I-I of FIG. 2B;

FIGS. 2D through 2F are cross-sectional views of a terminal unit taken along line C-C of FIG. 2A;

FIG. 3A is a cross-sectional view of an OELD according to another embodiment of the present invention;

FIGS. 3B through 3D are cross-sectional views of a terminal unit according to another embodiment of the present invention.

### DETAILED DESCRIPTION OF THE INVENTION

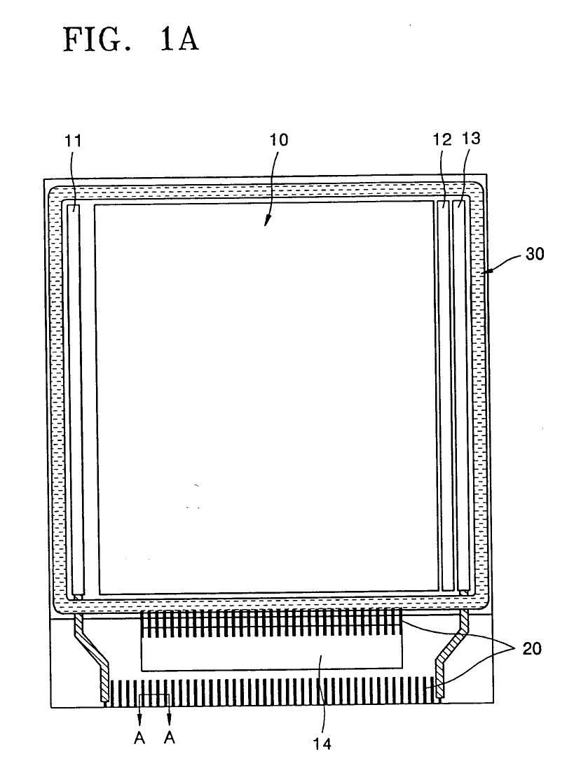

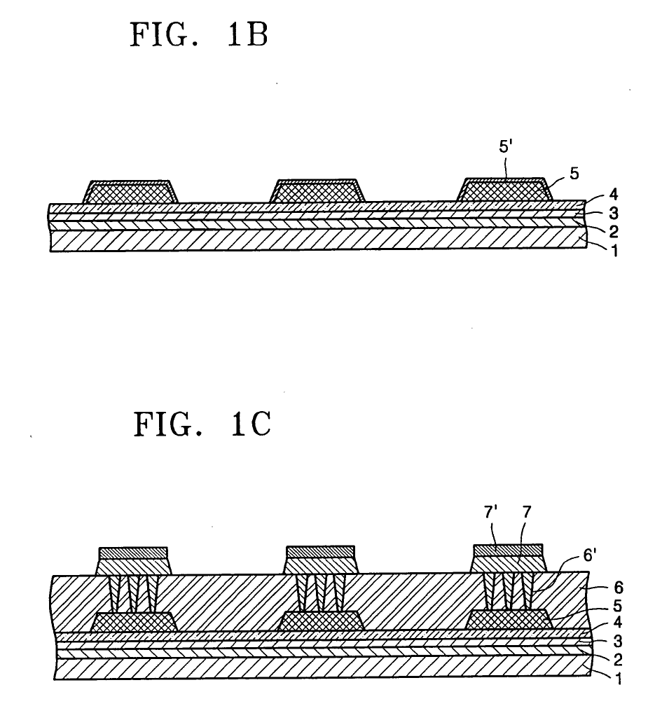

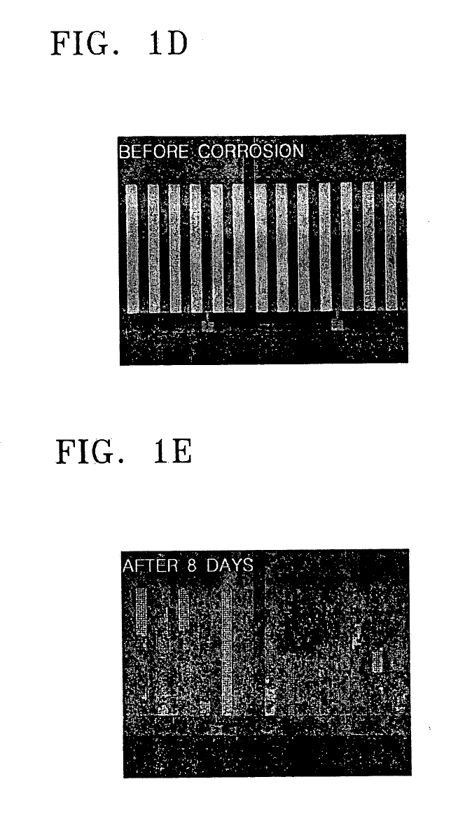

FIG. 1A is a plan view of a flat display device, especially an OELD. Referring to FIG. 1A, in an OELD, a display region 10 composed of pixels is formed on a substrate 1 (in FIG. 1B), wiring is formed on peripheral regions of the display region 10, and circuit units, such as electrode power supply lines 11 and 13 and a vertical driving circuit 12, and a sealing unit 30 that at least seals the display region 10 using a sealing member with a sealing substrate (not shown) are arranged thereon. Also, a pad unit 20 is arranged on at least a peripheral area of the display region 10.

FIG. 1B is a cross-sectional view taken along line A-A of FIG. 1A. Referring to FIG. 1B, the pad unit 20 includes a buffer layer 2, a gate insulating layer 3, and an interlayer 4 sequentially formed on the substrate 1. The buffer layer 2, the gate insulating layer 3, and the interlayer 4 are equivalent layers formed in the display region 10. A layer 5, which is the equivalent layer of source and drain electrodes in the display region 10 formed of MoW, is formed above the interlayer 4. The layer 5 acts as terminals of the pad unit 20.

However, oxide films 5′ can be formed on a surface of the terminals since these terminals are exposed to unfavorable conditions, such as humidity and high temperatures. The oxide films 5′ interrupt smooth electrical communications between terminals of an outside electrical device, such as an FPC or COG.

FIG. 1C is a cross-sectional view of a different type of pad unit. In a top emission display, the anode layer is a double layer composed of a reflection electrode and a transparent electrode. An electrode layer equivalent to one of the reflection electrode and the transparent electrode forms the uppermost part of a conductive layer of the pad unit 20. As depicted in FIG. 1C, a protective layer 6 is disposed on a surface of the equivalent layer 5 as the source/drain electrode, and the anode layers 7 and 7′ are disposed on the protective layer 6. The anode layer 7 is electrically connected to the equivalent layer 5 as the source/drain electrode through via holes 6′ formed in the protective layer 6.

However, the anode layers 7 and 7′ easily damaged by humidity since they are exposed to atmospheric air. That is, the reflection electrode 7 of the anode is formed of an aluminum (Al) layer or an Al alloy layer such as AlNd to increase reflectibility, and the transparent electrode 7′ of the anode is formed of a metal oxide layer, such as ITO. When an Al layer or a layer composed of AlNd is exposed to atmospheric air, as depicted in FIGS. 1D and 1E, the pad unit corrodes due to a galvanic phenomenon occurring at an interface between the metal layer and the metal oxide layer, and, in a worst case, the pad unit may peel off.

The present invention will now be described more fully with reference to the accompanying drawings in which exemplary embodiments of the invention are shown.

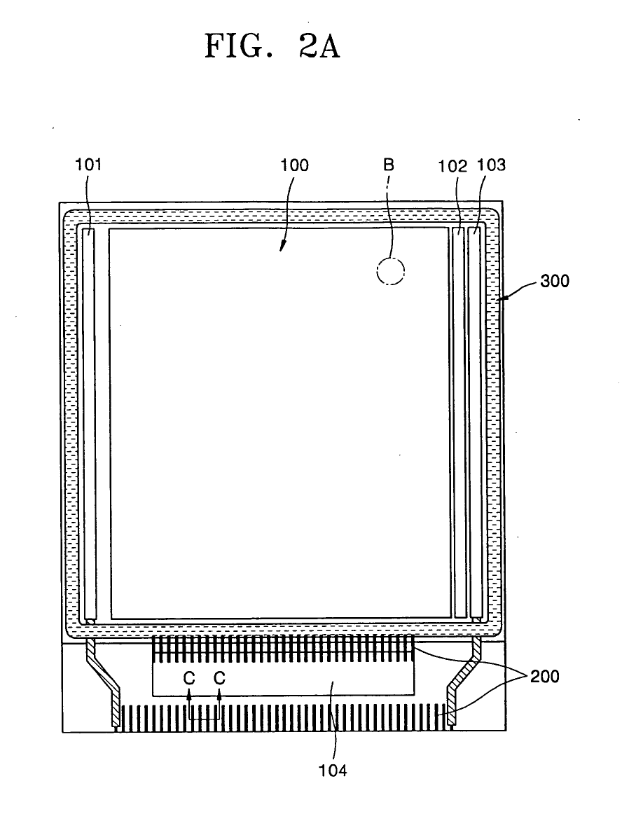

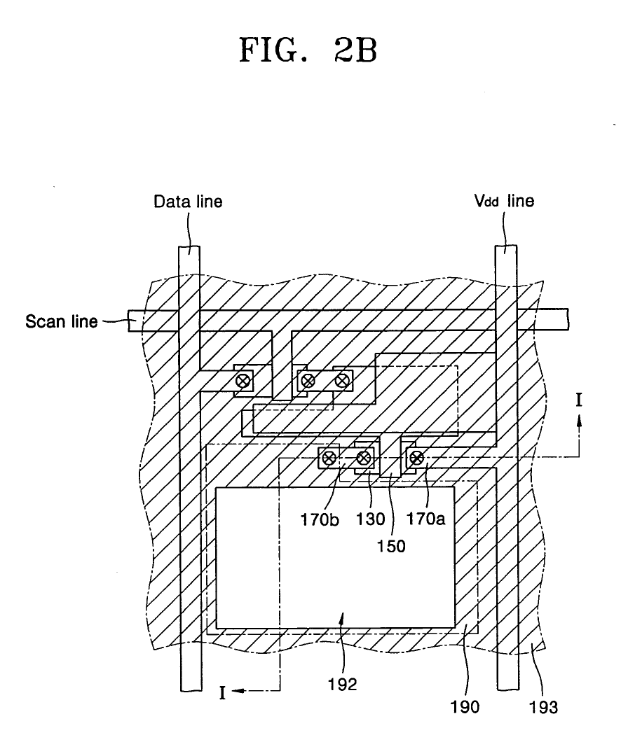

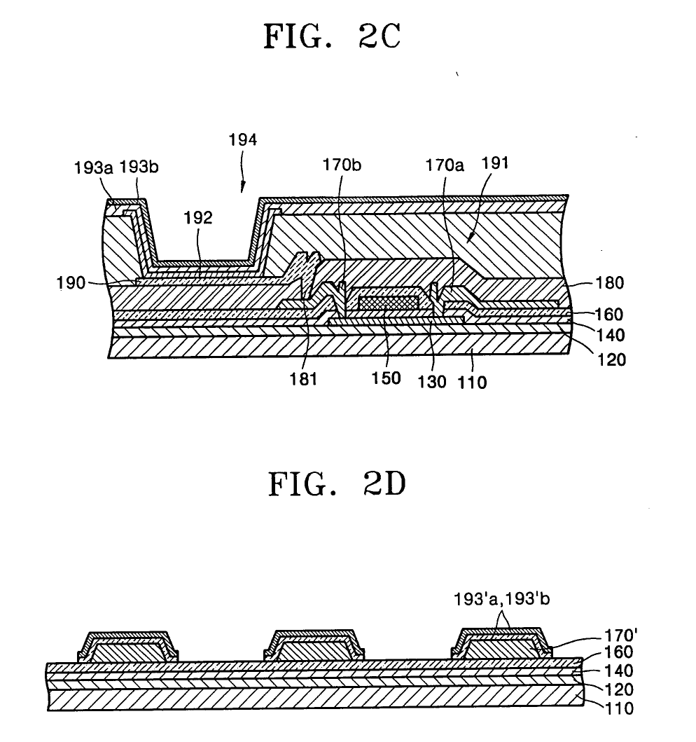

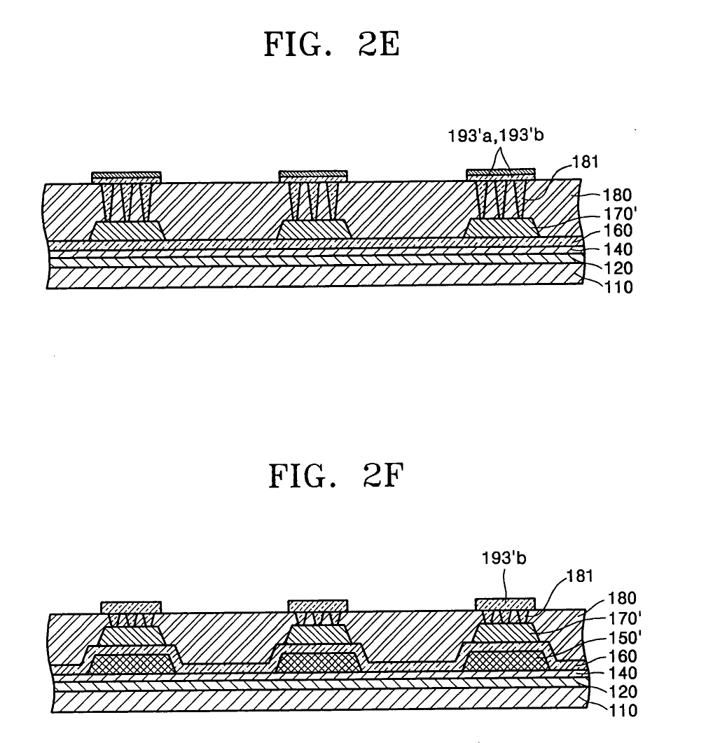

FIG. 2A is a plan view illustrating an OELD according to an embodiment of the present invention. Referring to FIG. 2A, a display region 100 composed of at least one pixel (element 194 in FIG. 2C is a sub-pixel) is formed on a surface of a substrate 110 (in FIG. 2C), and a terminal unit (pad unit) 200 composed of at least one terminal is disposed on an outer region of the display region 100.

Also, as depicted in FIG. 2A, the display region 100 is surrounded by a sealing member 300 and sealed by the sealing member 300. Electrode power supply lines 101 and 103 connected to a second electrode layer 193 (in FIG. 2C) of the display region 100 are formed in a sealing region formed by the sealing member 300. Also, a source electrode 170a of the display region 100 for applying electrical signals to a first electrode layer 190 (in FIG. 2C) of pixel is disposed in the sealing region formed by the sealing member 300. A vertical driving circuit unit 102 for supplying a scan signal to each of the pixels in the display region 100 can also be disposed in the sealing region. The terminal unit 200 can not only include electrode terminals extending from the display region 100 and terminals extending from driving circuits but can also include terminals connected to a COG horizontal driving circuit unit 104 since the horizontal driving circuit unit 104 for supplying data signals to each of the pixels in the display region 100 can be disposed in the terminal unit 200.

The present invention is not limited to the layout of various wiring and circuits depicted in FIG. 2A.

FIG. 2B is a magnified drawing of a portion of the display region 100 designated by “B” in FIG. 2A, and FIG. 2C is a cross-sectional view taken along line I-I in FIG. 2B.

Referring to FIGS. 2B and 2C, a buffer layer 120 is formed on a surface of a substrate 110, such as a glass substrate. The buffer layer 120 is formed of SiO₂ to a thickness of approximately 3000 Å.

A semiconductor active layer 130 is formed on a surface of the buffer layer 120. The semiconductor active layer 130 can be formed of an amorphous silicon layer or a polycrystalline silicon layer, but the present invention is not limited thereto. The semiconductor active layer 130 is composed of a source and drain region (not shown) and a channel region (not shown) doped with an N+ type or a P+ type dopant.

A gate electrode 150 is formed on an upper surface of the semiconductor active layer 130. As depicted in FIG. 2C, when a different TFT is electrically connected through a scan line, the electrical connection of the channel region is determined according to a signal from the data line supplied to the gate electrode 150 via a capacitor, and then the source and drain region is electrically connected. The gate electrode 150 is formed of a material such as MoW in consideration of tightness with adjacent layers, surface planarity of a layer stacked, and processability. To secure insulation of the semiconductor active layer 130 and the gate electrode 150, a gate insulating layer 140 formed of SiO₂ using Plasma Enhanced Chemical Vapor Deposition (PECVD) between the semiconductor active layer 130 and the gate electrode layer 150.

An interlayer 160 is formed on the gate electrode 150. The interlayer 160 can be a single layer or a double layer formed of SiO₂ or SiNx. Source and drain electrodes 170a and 170b are formed on the interlayer 160. The source and drain electrodes 170a and 170b are respectively electrically connected to the source region and the drain region of the semiconductor active layer 130 through contact holes formed between the interlayer 160 and the gate insulating layer 140.

A protection layer (passivation layer and/or planarizing layer) 180 is formed on the source/drain electrodes 170a and 170b and protects and planarizes a TFT thereunder. The protection layer 180 according to an embodiment of the present invention can be formed in many different configurations, that is, can be formed of an organic material or an inorganic material, and a single layer or a double layer which includes a SiNx layer as a lower layer and an organic layer such as benzocyclobutene (BCB) or acryl as an upper layer.

A first electrode layer 190 is disposed on a surface of the protective layer 180. An end of the first electrode layer 190 is connected to the drain electrodes 170a and 170b through a via hole 181 formed in the protective layer 180. An inorganic/organic Light Emitting Diode (LED) is disposed on a surface of the first electrode layer 190.

A pixel define layer 191 is formed on the protection layer 180 and the first electrode layer 190, and is patterned to expose a portion of the first electrode layer 190.

An organic light emitting unit 192 can be formed of a low molecular or polymer organic film. When the low molecular organic film is used, the organic light emitting Unit 192 Can Be Single Layered Or Multiple Layered From A Hole Injection Layer (Hil), A Hole Transport Layer HTL), an EMission Layer (EML), an Electron Transport Layer (ETL), and an Electron Injection Layer (EIL). A variety of organic materials such as copper phthalocyanine (CuPu), N,N′-Di(naphthalene-1-yl)-N,N′-diphenyl-benzidine (NPB), or tris-8-hydroxyquinoline aluminum (Alq3). These low molecular organic films can be formed by vapor deposition.

Polymer organic film can have a structure including approximately an HTL and an EML. PEDOT is used as the HTL and a polymer organic material such as poly-phenylenevinylene (PPV) and polyfluorene can be used as the EML. The HTL and EML can be formed by a screen printing method or an ink jet printing method.

A second electrode layer 193 is deposited on an entire surface of the organic light emitting unit 192, and the second electrode layer 193 is not limited to being deposited on the entire surface. The electrode power supply lines 101 and 103 are disposed on an outer region of the display region 100, and the second electrode layer 193 and the electrode power supply lines 101 and 103 can be electrically connected.

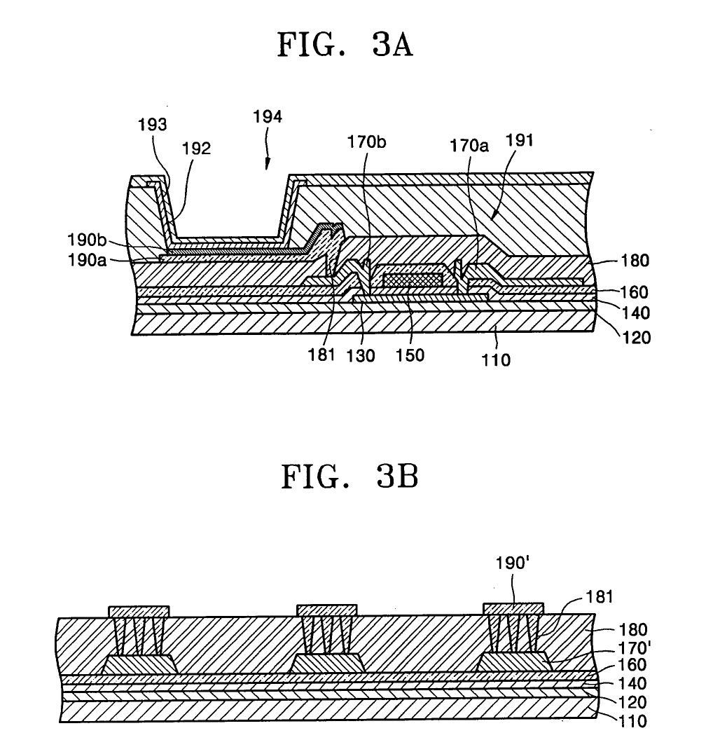

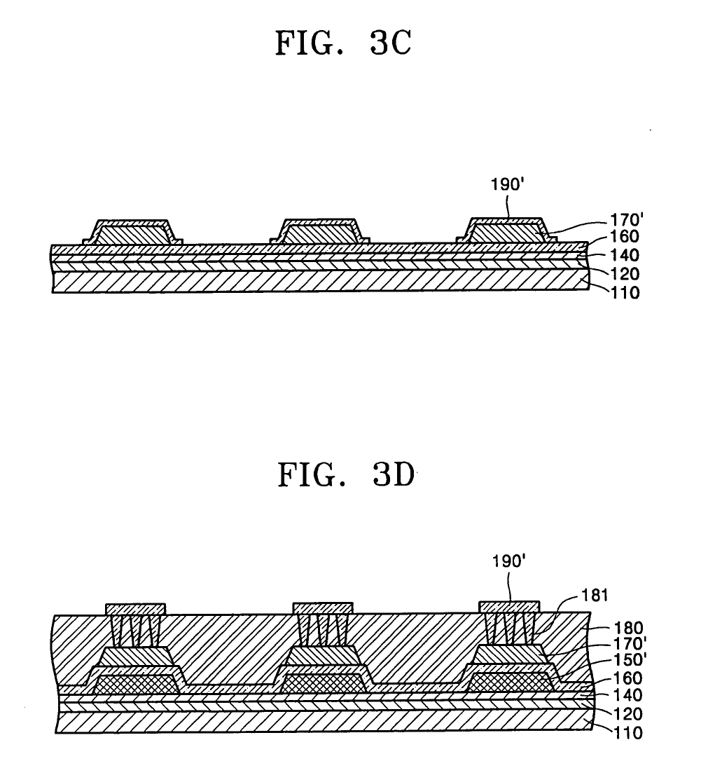

Terminals of the terminal unit 200 have at least one conductive layer of the conductive layers that constitute the display region 100, and can be formed as an upper terminal conductive layer and a lower terminal conductive layer, which are electrically connected to each other. That is, the lower terminal conductive layers can be formed to the equivalent layers, such as the gate electrode and/or the source/drain electrodes. The equivalent layer 190′ (in FIG. 3C) of the lower terminal conductive layers as the first electrode 190 of the display region 100 can be covered by upper terminal conductive layers such as the equivalent layer 193′ (in FIG. 2D) to the second electrode layer 193.

FIGS. 2D through 2F are cross-sectional views taken along line C-C of FIG. 2A, and illustrate a case when upper terminal conductive layers of the terminal unit 200 is formed to the equivalent layer 193′ to the second electrode layer, according to an embodiment of the present invention.

The lower terminal conductive layers of the terminal unit 200 in FIG. 2D are the equivalent layer 170′ to the source/drain electrodes of the display region 100, that is, conductive layers formed simultaneously as the source/drain electrodes. For example, when an OLED is a top emission OLED, the second electrode layer 193 is formed of a transparent electrode to increase the emission rate of light generated by the organic light emitting unit 192 through a sealing substrate (not shown). When the second electrode layer 193 acts as a cathode, it is formed of a material having a low work function. In the present embodiment depicted in FIG. 2D, the second electrode layer 193 is formed such that after forming a thin metal layer of Ag, Mg, and/or an alloy of these metals, a transparent metal oxide layer, such as an ITO layer or an IZO layer, is formed on the thin metal layer. When forming the second electrode layer 193 in a double layer as in the above structure, the terminals of the terminal unit 200 are preferably formed of a Mg:Ag metal layer 193a and an IZO layer 193b considering that the terminals are exposed to humidity.

Accordingly, as depicted in FIG. 2D, the upper terminal conductive layer 193′ can also be formed as a double layer of a metal layer 193a′ and a metal oxide layer 193b′. In order to prevent the formation of an oxide film when the metal layer is exposed to the outside, the metal layer 193a′ must be formed prior to forming the metal oxide layer 193b′, which is formed on the metal layer 193a′. However, the present invention is not limited thereto, that is, the upper terminal conductive layer 193′ can be formed as a single layer.

On the other hand, the upper terminal conductive layer 193′ is formed simultaneously with the second electrode layer 193. For example, the upper terminal conductive layer 193′ can be formed to have all layers of the second electrode layer 193 or a portion of the second electrode layer 193 using an opened or a closed mask on the terminal region of the terminal unit when depositing the second electrode layer 193. However, the upper terminal conductive layer 193′ is preferably formed to have all layers of the second electrode layer 193 in consideration of the process efficiency, but the present invention is not limited thereto.

A variety of configurations can be considered to dispose an equivalent layer to the second electrode layer 193, that is, the upper terminal conductive layer 193′ on the lower terminal conductive layers. For example, the upper terminal conductive layer 193′ can have a configuration to surround an equivalent layer to the source/drain electrode formed on the substrate, that is, the lower terminal conductive layer 170′ by being adjacent to the lower terminal conductive layer 170′. This case has an advantage of reducing electrical resistance when conducting since the lower terminal conductive layers which are equivalent layers to the source/drain electrodes that act as main terminals and the upper terminal conductive layer 193′ which is an equivalent layer to the second electrode layer 193 are disposed close to each other. The metal layer 193a′ is preferably formed of a metal other than Al, such as Mg:Ag, and the metal oxide layer 193b′ is preferably formed of IZO to prevent a galvanic phenomenon of the metal layer 193a′ and the metal oxide layer 193b′ due to humidity.

FIG. 2E is another example of a configuration in which the upper terminal conductive layer 193′ is disposed on the lower terminal conductive layers. Referring to FIG. 2E, to protect the equivalent layer 170′ from the source/drain electrodes, the protective layer 180 of the display region 100 can be extended on a surface of the equivalent layer 170′ to the source/drain electrodes. Afterward, via holes 181 are formed in the protective layer 180, and the equivalent layer 170′ to the source/drain electrodes and the metal layer 193a′ can be electrically connected via the via holes 181. In this case also, the metal layer 193a′ is preferably formed of a metal other than Al, and more preferably, is formed of Mg:Al.

In the above embodiment of the present invention, the equivalent layer 170′ to the source/drain electrodes act as the terminals of the terminal unit 200, but the present invention is not limited thereto. That is, as depicted in FIG. 2F, the equivalent layer 150′ to the gate electrode of the display region 100 can further be disposed, and the equivalent layers 150′ to the gate electrode layer, alone or together, can act as the lower terminal conductive layers. The equivalent layer 193′ to the second electrode layer 193 is not necessarily a double layer, but as depicted in FIG. 2F, can be a single layer such as an IZO layer 193b′. In the present embodiment, a top emission OLED is described for explanation convenience, but the present embodiment can also be applied to a variety of display devices such as a bottom emission OLED.

FIGS. 3A though 3D are cross-sectional views illustrating a case using the equivalent layer 190′ to the first electrode layer 190 as the upper terminal conductive layer of the terminal unit 200 according to another embodiment of the present invention.

For example, when the OLED is a top emission OLED and the first electrode layer 190 is used as an anode, as depicted in FIG. 3A, the first electrode layer 190 includes a reflection electrode 190a, which is a thin metal layer formed of Al or AlNd, for increasing emission of light generated by the organic light emitting unit 192 through a sealing substrate (not shown) and a transparent metal oxide layer having a large work function such as ITO or IZO on the reflection layer 190a.

When the first electrode layer 190 is formed as a double layer, as depicted in FIGS. 3B through 3D, the transparent metal oxide layer 190′ of the equivalent layer (as the upper terminal conductive layer) to the first electrode layer 190 is disposed on the equivalent layer 170′ (as the lower terminal conductive layer) to the source/drain electrodes of the terminal unit 200 to reduce the risk of damage to the terminal unit 200 due to the galvanic phenomenon between different metals constituting the terminal unit 200 that are exposed to high temperatures and humidity. To form the transparent metal oxide layer 190′ as the upper terminal conductive layer of the terminals of the terminal unit 200, after forming the metal layer 190a of the first electrode layer 190 in the display region 100, the metal layer 190a is wet etched to a region corresponding to the terminal unit 200 when patterning the metal layer 190a. Afterward, the transparent metal oxide layer 190′ is deposited on the display region 100 and then patterned. However, the present invention is not limited thereto.

A variety of configurations to dispose the transparent metal oxide layer 190′ as an upper terminal conductive layer on the lower terminal conductive layer of the terminal unit 200 can be considered. That is, as depicted in FIG. 3B, they can have a structure in which the transparent metal oxide layer 190′ is disposed close to the equivalent layer 170′ to the source/drain electrodes. In this case, electrical resistance between the lower terminal conductive layer such as the equivalent layer 170′ to the source/drain electrodes that act as the main terminals and the transparent metal oxide layer 190′ as the upper terminal conductive layer can be reduced since they are disposed close to each other.

Another configuration to dispose the upper terminal conductive layer of the terminal unit 200 on the lower terminal conductive layer is shown in FIG. 3C. To protect the equivalent layer 170′ to the source/drain electrodes as depicted in FIG. 3C, the protective layer 180 of the display region 100 can be disposed on a surface of the equivalent layer 170′ to the source/drain electrodes. Afterward, the via holes 181 are formed in the protective layer 180, and the equivalent layer 170′ to the source/drain electrodes and the transparent metal oxide layer 190′ can be electrically connected via the via holes 181. In this case also, the transparent metal oxide layer 190′ is preferably formed of ITO or IZO.

In the present embodiment, the equivalent layer 170′ to the source/drain electrodes act as the main terminals of the terminal unit 200. However, the present invention is not limited thereto. That is, as depicted in FIG. 3D, the terminal can further include the equivalent layer to the gate electrode 150′ of the display region 100 or the gate electrode 150′ alone can act as the terminal.

In the present embodiment, a top emission OLED is described for explanation convenience, but the present embodiment can also be applied to a variety of display devices such as a bottom emission OLED.

The above embodiments of the present invention are described with respect to the AM matrix OLED. However, the present invention is not limited thereto. That is, the present invention can be applied to a variety of modifications such as an ILED and a PM matrix OLED.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

1. A Light Emitting Display (LED) comprising:
a display region including first and second electrodes having at least one layer formed on a substrate layer and a light emitter arranged between a first and second electrodes; and
a terminal unit including at least one terminal arranged on an outer region of the display region;
wherein at least a portion of the at least one terminal of the terminal unit includes an upper terminal conductive layer and a lower terminal conductive layer, each including at least one layer, and at least one layer of the upper terminal conductive layer is of a material identical to at least a portion of the second electrode layer.

2. The LED of claim 1, wherein the upper terminal conductive layer includes at least one layer selected from the group consisting of an Mg:Ag layer, an ITO layer, and an IZO layer.

3. The LED of claim 1, wherein the lower terminal conductive layer includes a terminal conductive layer of a material identical to the source/drain electrodes of the display region.

4. The LED of claim 1, wherein the lower terminal conductive layer includes a terminal conductive layer of a material identical to the gate electrodes of the display region.

5. The LED of claim 1, further comprising a protective layer of the lower part of the first electrode of the display region, the protective layer interposed between the upper terminal conductive layer and the lower terminal conductive layer.

6. The LED of claim 5, wherein the protective layer includes at least one via hole and wherein the upper terminal conductive layer and the lower terminal conductive layer are electrically connected via the via holes.

7. The LED of claim 1, wherein a surface of the upper terminal conductive layer and a surface of the lower terminal conductive layer are arranged close to each other.

8. The LED of claim 1, wherein the lower terminal conductive layer is of MoW.

9. The LED of claim 2, wherein the lower terminal conductive layer is of MoW.

10. The LED of claim 3, wherein the lower terminal conductive layer is of MoW.

11. The LED of claim 4, wherein the lower terminal conductive layer is of MoW.

12. The LED of claim 5, wherein the lower terminal conductive layer is of MoW.

13. The LED of claim 6, wherein the lower terminal conductive layer is of MoW.

14. The LED of claim 7, wherein the lower terminal conductive layer is of MoW.

15. A method of manufacturing a Light Emitting Display (LED), the method comprising:
arranging a display region to include first and second electrodes having at least one layer arranged on a substrate layer and a light emitter arranged between the first and second electrodes; and
arranging a terminal unit including at least one terminal arranged on an outer region of the display region, arranging the terminal unit including:
forming a lower terminal conductive layer with at least one layer equivalent to a gate electrode layer and one layer equivalent to source/drain electrodes of the display region; and
forming the upper terminal conductive layer equivalent to at least a portion of the second electrode layer of the display region.

16. The method of claim 15, further comprising arranging a protective layer of the display region in the terminal unit and connecting the lower terminal conductive layer and the upper terminal conductive layer by forming via holes in the terminal unit before forming of the upper terminal conductive layer.

17. The method of claim 15, wherein the forming of the upper terminal conductive layer includes forming of a transparent metal oxide layer.

18. The method of claim 16, wherein the forming of the upper terminal conductive layer includes forming of a transparent metal oxide layer.

19. The method of claim 17, wherein the transparent metal oxide layer is at least one of IZO and ITO.

20. The method of claim 18, wherein the transparent metal oxide layer is at least one of IZO and ITO.

21. The method of claim 17, wherein the forming of the upper terminal conductive layer includes interposing an Mg:Ag layer before forming the transparent metal oxide layer.

22. The method of claim 18, wherein the forming of the upper terminal conductive layer includes interposing an Mg:Ag layer before forming the transparent metal oxide layer.
